(19) United States
(12) Patent Application Publication
(10) Pub. No.: US 2020/0134494 A1
(43) Pub. Date: Apr. 30, 2020

(54) Systems and Methods for Generating Artificial Scenarios for an Autonomous Vehicle

(71) Applicant: UATC, LLC, San Francisco, CA (US)

(72) Inventor: Arun Dravid Kain Venkatadri, Pittsburgh, PA (US)

(21) Appl. No.: 16/199,843

(22) Filed: Nov. 26, 2018

Related U.S. Application Data
(60) Provisional application No. 62/751,061, filed on Oct. 26, 2018.

(51) Int. Cl. G06N 5/04; G05D 1/02; G06N 20/00

(52) U.S. Cl. CPC G06N 5/048; G05D 1/0221; G06N 3/088; G05D 2201/0213; G06N 20/00

(57) ABSTRACT

Systems and methods for vehicle simulation are provided. A method can include obtaining generator input data indicative of one or more parameter values, and inputting the generator input data into a machine-learned generator model that is configured to generate artificial data based at least in part on the generator input data. The artificial data can include data representing an artificial scenario associated with an autonomous vehicle. The method can include obtaining an output of the machine-learned generator model that can include the artificial data, and inputting the artificial data into a machine-learned discriminator model to generate authenticity data representing an authenticity associated with the artificial scenario of the artificial data. The method can include obtaining an output of the machine-learned discriminator model that can include the authenticity data. The method can include selecting the artificial scenario in the artificial data.

### PRIORITY CLAIM

The present application claims the benefit of priority of U.S. Provisional Patent Application No. 62/751,061, filed on Oct. 26, 2018, entitled “Systems and Methods for Generating Artificial Scenarios for an Autonomous Vehicle,” the disclosure of which is incorporated by reference in its entirety.

### FIELD

The present disclosure relates generally to devices, systems, and methods for generating artificial scenarios for autonomous vehicles.

### BACKGROUND

An autonomous vehicle can be capable of sensing its environment and navigating with little to no human input. In particular, an autonomous vehicle can observe its surrounding environment using a variety of sensors and can attempt to comprehend the environment by performing various processing techniques on data collected by the sensors. Given knowledge of its surrounding environment, the autonomous vehicle can navigate through such surrounding environment.

### SUMMARY

Aspects and advantages of the present disclosure will be set forth in part in the following description, or may be learned from the description, or may be learned through practice of the embodiments.

An example aspect of the present disclosure is directed to a computer-implemented method for vehicle simulation. The method can include obtaining, by a computing system that includes one or more computing devices, generator input data indicative of one or more parameter values. The method can include inputting, by the computing system, the generator input data into a machine-learned generator model that is configured to generate artificial data based at least in part on the generator input data. The artificial data can include data representing an artificial scenario associated with an autonomous vehicle. The method can include obtaining an output of the machine-learned generator model, by the computing system, in response to inputting the generator input data into the machine-learned generator model, the output including the artificial data. The method can include inputting, by the computing system, the artificial data into a machine-learned discriminator model to generate authenticity data representing an authenticity associated with the artificial scenario of the artificial data. The method can include obtaining an output of the machine-learned discriminator model, by the computing system, in response to inputting the artificial data into the machine-learned discriminator model, the output including the authenticity data. The method can include selecting, by the computing system, the artificial scenario in the artificial data when the authenticity associated with the artificial scenario is greater than an authenticity threshold value.

Another example aspect of the present disclosure is directed to a computing system including one or more processors and a memory including one or more computer-readable media. The memory can store computer-readable instructions that when executed by the one or more processors can cause the one or more processors to perform operations. The operations can include generating artificial data representing one or more artificial scenarios for an autonomous vehicle. The operations can include analyzing the artificial data to determine authenticity data representing an authenticity associated with the artificial data. The operations can include selecting an artificial scenario from the artificial data, when the authenticity associated with the artificial scenario is greater than an authenticity threshold value.

Yet another example aspect of the present disclosure is directed to one or more tangible non-transitory computer-readable media storing computer-readable instructions that when executed by one or more computing devices cause the one or more computing devices to perform operations. The operations can include generating artificial data representing one or more artificial environments of an autonomous vehicle or one or more artificial logs of an autonomous vehicle. The operations can include analyzing the artificial data to determine authenticity data representing an authenticity associated with the artificial data. The operations can include selecting an artificial environment or an artificial log from the artificial data, when the authenticity data is greater than an authenticity threshold value.

Other example aspects of the present disclosure are directed to systems, methods, vehicles, apparatuses, tangible, non-transitory computer-readable media, and memory devices for generating artificial scenarios for autonomous vehicles.

The autonomous vehicle technology described herein can help improve the safety of passengers of an autonomous vehicle, improve the safety of the surroundings of the autonomous vehicle, improve the experience of the rider and/or operator of the autonomous vehicle, as well as provide other improvements as described herein. Moreover, the autonomous vehicle technology of the present disclosure can help improve the ability of an autonomous vehicle to effectively provide vehicle services to others and support the various members of the community in which the autonomous vehicle is operating, including persons with reduced mobility and/or persons that are underserved by other transportation options. Additionally, the autonomous vehicle of the present disclosure may reduce traffic congestion in communities as well as provide alternate forms of transportation that may provide environmental benefits.

These and other features, aspects, and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth below, which make reference to the appended figures, in which:

FIG. 1 depicts an example vehicle computing system onboard an autonomous vehicle, according to example embodiments of the present disclosure;

FIG. 2 depicts a block diagram of an example computing system that generates artificial data for autonomous vehicles, according to example embodiments of the present disclosure;

FIG. 3 depicts a block diagram of an example GAN model according to example embodiments of the present disclosure;

FIG. 4 depicts a block diagram of an example GAN model according to example embodiments of the present disclosure;

FIG. 5 depicts an example artificial scenario computing system and a simulation/testing system according to example embodiments of the present disclosure;

FIG. 6 depicts an example simulated environment according to example embodiments of the present disclosure;

FIG. 7 depicts a block diagram of an example processing pipeline according to a first example embodiment of the present disclosure;

FIG. 8 depicts a block diagram of an example processing pipeline according to a second example embodiment of the present disclosure;

FIG. 9 depicts a flow chart diagram of an example method to perform simulation according to example embodiments of the present disclosure; and

FIG. 10 depicts a block diagram of an example artificial scenario computing system according to example embodiments of the present disclosure.

Reference numerals that are repeated across plural figures are intended to identify the same components or features in various implementations.

### DETAILED DESCRIPTION

Example aspects of the present disclosure are generally directed to vehicle simulations, and in particular to generating artificial scenarios (e.g., one or more artificial environments and/or artificial logs) for autonomous vehicles. For example, an artificial environment can be simulated to create a virtual world and allow for the measurement of vehicle system performance, and an artificial log can be used for the testing of vehicle system performance. Systems and methods consistent with the present disclosure can include one or more general adversarial network (GAN) models that can be used to generate artificial data representing the artificial scenarios. The GAN model(s) can include one or more machine-learned generator models that can generate the artificial data and one or more machine-learned discriminator models that can authenticate the artificial data (e.g., to determine whether the artificial data is representative of a real-world scenario). The interplay between the machine-learned generator model(s) and machine-learned discriminator model(s) can allow the GAN model(s) to generate artificial data that includes completely new scenarios. As an example, if there is insufficient real-world data corresponding to a real-world scenario that includes a five-way traffic intersection, then the system can use the GAN model(s) to generate artificial environment data for simulating the five-way intersection. As another example, if there is insufficient real-world data corresponding to a real-world scenario in a target city (e.g., San Francisco), then the system can use the GAN model(s) to generate artificial environment data for simulating the real-world scenario in the target city (e.g., based on real-world data corresponding to the real-world scenario in a different city). As another example, if there is insufficient real-world data corresponding to state/diagnostics information of an autonomy system onboard an autonomous vehicle operating in the real-world, then the system can use the GAN model(s) to generate artificial log data for the autonomy system. In this way, the systems and methods described herein can be used to generate scenarios and/or logs for improved autonomous vehicle simulations as well as technology development and testing.

More particularly, an autonomous vehicle (e.g., ground-based vehicle, etc.) can include various systems and devices configured to control the operation of the vehicle. For example, an autonomous vehicle can include an onboard vehicle computing system (e.g., located on or within the autonomous vehicle) for operating the autonomous vehicle. The vehicle computing system can obtain sensor data from sensor(s) onboard the vehicle (e.g., cameras, LIDAR, RADAR, etc.). The vehicle computing system can include an autonomy system that can attempt to comprehend the vehicle's surrounding environment by performing various processing techniques on the sensor data, predict the motion of objects surrounding the vehicle (e.g., pedestrians, bicycles, other vehicles, etc.), and generate an appropriate motion plan through the vehicle's surrounding environment.

To help improve system functionality and software capabilities, the vehicle computing system functionality can be tested in an offline, simulated environment. For instance, a vehicle computing engine can be utilized with a simulation/testing system that is configured to run simulations and/or testing. The vehicle computing engine can include one or more software stacks that are the same as or at least similar to the software stack utilized on an autonomous vehicle (e.g., outside of a testing environment). The software stack(s) can include, for example, a sensor software stack, autonomy software stack, vehicle control software stack, communications software stack, and/or another software stack. In some implementations, the software stack(s) utilized in the testing environment can also, or alternatively, include software (e.g., an updated version) that has not been deployed onto an autonomous vehicle. The vehicle computing system utilized in the simulation/testing system can include the components of a vehicle computing system that would be included in an autonomous vehicle that is acting outside of a testing scenario (e.g., deployed in the real-world for a vehicle service). For example, the vehicle computing system can include various sub-systems that cooperate to perceive the simulated environment of the simulated autonomous vehicle, predict object motion, and determine a motion plan for controlling the motion of a simulated autonomous vehicle.

The technology of the present disclosure provides an improved approach to generating artificial scenarios (e.g., one or more artificial environments and/or artificial logs) that may be used for simulation and/or testing. According to aspects of the present disclosure, an artificial scenario computing system can be configured to generate the artificial scenarios. For instance, the artificial scenario computing system can obtain real-world data (e.g., map data, sensor data, log data, etc.) in order to, for example, generate artificial data representing one or more artificial environments and/or one or more artificial logs. In some implementations, the real-world data can include data indicative of one or more objects in one or more environments. As an example, the real-world data can include map data representing one or more environments, and object data representing one or more objects in the one or more environments. As another example, the real-world data can include real-world sensor data representing an environment. For example, the sensor data (e.g., camera image data, LIDAR cloud data, etc.) can include information that describes the location of one or more objects within the environment at one or more times. As another example, the real-world data can include real-world log data representing state and/or diagnostics information associated with one or more objects in an environment. For example, the log data can include state and/or diagnostics information associated with one or more systems (e.g., sensor system, autonomy system, vehicle control system, communications system, memory system, etc.) onboard a vehicle operating in the environment.

In some implementations, at least a portion of the real-world data can be acquired by one or more autonomous vehicles operating in the real-world. For instance, as described herein, the autonomous vehicle can include a sensor system (e.g., for obtaining sensor data representing an environment proximate to one or more sensors onboard the autonomous vehicle), autonomy system (e.g., for planning and executing autonomous navigation), vehicle control system (e.g., for controlling one or more systems responsible for powertrain, steering, braking, etc.), communications system (e.g., for communicating with one or more other computing system(s)), and memory system (e.g., for storing a motion plan of the autonomous vehicle, map information, traffic/weather information, etc.). Other autonomous vehicles described herein can be configured in a similar manner.

The autonomous vehicle can execute the generated motion plan to control an operation of the autonomous vehicle in the environment. As the autonomous vehicle operates, it can continue to obtain sensor data from the sensor system to refine the motion plan and react to changes in the environment. Additionally, or alternatively, the autonomous vehicle can obtain log data representing state/diagnostic information associated with the autonomous vehicle (e.g., sensor system, autonomy system, vehicle control system, communications system, memory system, etc.).

In some implementations, the artificial scenario computing system can obtain the real-world data from the autonomous vehicle(s). For example, the artificial scenario computing system can obtain the sensor data and/or log data from the vehicle computing system onboard an autonomous vehicle.

In some implementations, the real-world data can be human-labeled and/or machine labelled to indicate one or more classifications, characteristics, and/or properties associated with one or more objects represented by the real-world data. The labeled real-world data can be used to train one or more general adversarial network (GAN) models that can be used to generate artificial data. The GAN model(s) can include one or more machine-learned generator models that can generate the artificial data and one or more machine-learned discriminator models that can authenticate the artificial data (e.g., to determine whether the artificial data is representative of a real-world scenario). The real-world data can be used to train the machine-learned generator model(s) and/or the machine-learned discriminator model(s) associated with the GAN model(s). For example, the labeled real-world data can be utilized as ground-truth data to determine the accuracy and/or development of the GAN model(s) as it is trained. By training the GAN model(s) using the real-world data, it is possible to generate high quality artificial data (e.g., for measurement, development, testing, etc.).

In addition to, or in the alternative to, utilizing real-world data, the artificial scenario computing system can obtain generator input data in order to, for example, generate artificial data representing one or more artificial environments and/or one or more artificial logs. In some implementations, the generator input data can include parameter input data representing one or more parameters for generating the artificial data. In particular, the parameter input data can include environment parameter data representing one or more parameters for generating one or more artificial environments, and/or log parameter data representing one or more parameters for generating one or more artificial logs. The machine-learned generator model(s) can use the parameter input data to generate the artificial data.

The environment parameter data can include, for example, one or more parameters that indicate an environment locale (e.g., urban, suburban, rural, etc.), one or more travel ways and their characteristics (e.g., position, orientation, direction of traffic, number of lanes, traffic speed, etc.), one or more objects (e.g., vehicles, bicycles, pedestrians, buildings, barriers, obstacles, etc.) and their characteristics (e.g., type, properties, position, path, etc.). As an example, if the environment parameter data includes a parameter representing an environment locale set to “San Francisco”, then an artificial environment that is generated based on the environment parameter data can be similar to the city of San Francisco. As another example, if the environment parameter data includes a parameter representing a number of pedestrians set to “10”, a number of vehicles set to “4”, and a number of travel ways set to “2”, and a number of intersections set to “1”, then an artificial environment that is generated based on the environment parameter data can include 2 travel ways that intersect each other, 4 vehicles, and 10 pedestrians.

The log parameter data can include, for example, a target object for which to generate artificial log data (e.g., sensor system log, autonomy system log, vehicle control system log, communications log, etc.), a position of the object, an orientation of the object, a time-window for the artificial log data, etc. As an example, if the log parameter data includes one or more parameters representing a target object as the autonomy system onboard an autonomous vehicle, then an artificial log that is generated based on the log parameter data can correspond to the autonomy system. As another example, if the log parameter data includes one or more parameters representing a camera sensor onboard an autonomous vehicle that is orientated in a direction of travel of the autonomous vehicle, and positioned on the roof of the autonomous vehicle, then an artificial log that is generated based on the log parameter data can correspond to the camera system capturing camera data of an environment in front of the autonomous vehicle.

In some implementations, the generator input data can include variance input data representing one or more variance threshold values for one or more parameters in the parameter input data. In particular, the variance input data can include environment variance data associated with environment parameter data and/or log variance data associated with log parameter data. The environment variance data can represent one or more variance threshold values for one or more parameters in the environment parameter data. The log variance data can represent one or more variance threshold values for one or more parameters in the log parameter data. The machine-learned generator model(s) can use the parameter input data and variance input data to generate the artificial data.

As an example, if the environment parameter data includes a parameter representing a number of pedestrians set to “10”, then a variance threshold value for the parameter can include “+/−2”. Each artificial environment that is generated based on the environment parameter data and associated environment variance data can include anywhere between 8 to 12 pedestrians.

As another example, if the environment parameter data includes a parameter representing a motion path of a pedestrian, then a variance threshold value for the parameter can include an acceptable deviation from the motion path at one or more points along the motion path. Each artificial environment that is generated based on the environment parameter data and associated environment variance data can include a different motion path for the pedestrian that is within the acceptable deviation.

As another example, if the log parameter data includes a parameter representing an error rate of an autonomy system, then a variance threshold value for the parameter can include an acceptable deviation from the error rate. Each artificial log that is generated based on the log parameter data and log variance data can be based on a different error rate that is within the acceptable deviation.

In some implementations, the artificial scenario computing system can obtain the generator input data based at least in part on an input from a user, predetermined input data, and/or existing artificial data. As an example, a user can input generator input data via one or more input devices connected to the system. The data input by the user can specify one or more parameters and associated variance values for one or more artificial environments and/or artificial logs that are desired by the user. As another example, a user can direct the system to obtain predetermined input data from a local or remote memory location. The predetermined input data can include one or more parameters and associated variance values for one or more artificial environments and/or artificial logs. As another example, the computing system can obtain existing artificial data. The existing artificial data can represent previously generated artificial data (e.g., one or more previously generated artificial environments and/or artificial logs). The artificial scenario computing system can extract generator input data (e.g., parameter input data, variance input data) that was used to generate the existing artificial data from the existing artificial data.

According to aspects of the present disclosure, the artificial scenario computing system can input the generator input data into the machine-learned generator model(s), and obtain the artificial data as an output of the machine-learned generator model(s) in response to the generator input data. For instance, in some implementations, the machine-learned generator model(s) can be configured to receive environment parameter data and associated environment variance data. In response, the machine-learned generator model(s) can generate artificial data that includes one or more artificial environments based on the environment parameter data and environment variance data. In some implementations, the machine-learned generator model(s) can be configured to receive log parameter data and associated log variance data. In response, the machine-learned generator model(s) can generate artificial data that includes one or more artificial logs based on the log parameter data and log variance data.

In some implementations, the machine-learned generator model(s) can be configured to receive existing artificial data. In response, the machine-learned generator model(s) can generate artificial data that includes one or more artificial environments and/or artificial logs based on generator input data extracted from the existing artificial data.

According to aspects of the present disclosure, the artificial scenario computing system can input the artificial data into the machine-learned discriminator model(s), and obtain the authenticity data as an output of the machine-learned discriminator model(s) in response to the artificial data. For instance, the machine-learned discriminator model(s) can be configured to receive artificial data. In response, the machine-learned discriminator model(s) can generate authenticity data associated with the artificial data. As an example, the machine-learned discriminator model(s) can determine an authenticity associated with each parameter used to generate the artificial data and/or determine an overall authenticity associated with the artificial data (e.g., authenticity of a simulated scenario, authenticity of a simulated log data set, etc.). The machine-learned discriminator model(s) can determine the authenticity data based on the authenticity for each parameter and/or the overall authenticity.

In some implementations, the machine-learned discriminator model(s) can be configured to receive the artificial data and real-world data. In response, the machine-learned discriminator model(s) can generate authenticity data associated with the artificial data, based on the real-world data. As an example, the machine-learned discriminator model(s) can determine an authenticity associated with each parameter used to generate the artificial data and/or determine an overall authenticity associated with the artificial data, based on the real-world data. The machine-learned discriminator model(s) can determine the authenticity data based on the authenticity for each parameter and/or the overall authenticity.

In some implementations, the machine-learned discriminator model(s) can include one or more machine-learned classifier models that can classify one or more parts of an artificial scenario based on authenticity associated with the part. For example, if the machine-learned classifier model(s) determine that a first part of an artificial scenario is associated with an authenticity that exceeds 75% certainty, then the machine-learned classifier model(s) can classify the first part as “very authentic.” If the machine-learned classifier model(s) determine that a second part of the artificial scenario is associated with an authenticity between 25% and 75% certainty, then the machine-learned classifier model(s) can classify the second part as “authentic.” If the machine-learned classifier model(s) determine that a third part of the artificial scenario is associated with an authenticity below 25% certainty, then the machine-learned classifier model(s) can classify the third part as “not authentic.”

In some implementations, the machine-learned generator model(s) can be configured to receive existing artificial data and associated authenticity data. In response, the machine-learned generator model(s) can generate artificial data that includes one or more artificial environments and/or artificial logs based on generator input data extracted from the existing artificial data and the authenticity data. The authenticity data can include artificial environment authenticity data associated with an artificial environment (e.g., how well the artificial environment represents a real-world environment) and/or artificial log authenticity data associated with an artificial log (e.g., how well the artificial log represents a real-world log).

As an example, in response to receiving artificial environment authenticity data associated with a previously generated first artificial environment, the machine-learned generator model(s) can generate a second artificial environment that augments the first artificial environment based on the artificial environment authenticity data such that the second artificial environment is likely to be determined as more authentic than the first artificial environment.

As another example, in response to receiving artificial log authenticity data associated with a previously generated first artificial log, the machine-learned generator model(s) can generate a second artificial log that augments the first artificial log based on the artificial log authenticity data such that the second artificial environment is likely to be determined as more authentic than the first artificial log.

According to aspects of the present disclosure, the artificial scenario computing system can select an artificial scenario (e.g., artificial environment or an artificial log) from the artificial data, based at least in part on the authenticity data. As an example, the machine-learned generator model(s) can generate artificial data that includes a first artificial environment, and the machine-learned discriminator model(s) can generate environment authenticity data associated with the first artificial environment. If environment authenticity data associated with a first artificial environment indicates that the artificial environment exceeds an authenticity threshold value (e.g., the machine-learned discriminator model(s) determines that the first artificial environment is representative of a real-world environment), then the artificial scenario computing system can select the first artificial environment for use in a simulation of the first artificial environment. The artificial scenario computing system can provide such data to a simulation/testing system (included and/or separate from the artificial scenario computing system), which can perform a simulation based at least in part on the first artificial environment. As another example, the machine-learned generator model(s) can generate artificial data that includes a first artificial log, and the machine-learned discriminator model(s) can generate log authenticity data associated with the first artificial log. If log authenticity data associated with a first artificial log indicates that the artificial log exceeds an authenticity threshold value, then the artificial scenario computing system can select the first artificial log for use in various testing. The artificial scenario computing system can provide the first artificial log to a simulation/testing system, which can perform development testing based at least in part on the first artificial log. This can include, for example, development testing of software versions that may be included an autonomous vehicle's autonomy software stack.

The systems and methods described herein may provide a number of technical effects and benefits. For instance, a computing system can include one or more GAN models (e.g., a combination of one or more machine-learned generator model(s) and one or more machine-learned discriminator model(s)) that are configured to generate artificial environment data and/or artificial log data. The GAN(s) can generate the artificial data based on real-world data such that the generated artificial data represents one or more artificial environments and/or artificial logs that are likely to be determined as authentic. In particular, the GAN(s) can be trained to generate the artificial data based on the real-world data and to generate the authenticity data associated with the artificial data. By including a feedback of the authenticity data when generating the artificial data, the artificial environments and/or artificial logs represented by the artificial data can be generated with increased accuracy. In this way, the systems and methods described herein can be used to generate new scenarios and/or logs to improve a speed and efficiency of autonomous vehicle development and testing.

The systems and methods described herein may also provide resulting improvements to computing technology tasked with simulation. Improvements in the speed and accuracy of generating authentic artificial data can directly improve operational speed and reduce processing requirements for computing systems, ultimately resulting in more efficient resource use. In this way, valuable computing resources within a computing system that would have otherwise been needed for such tasks can be reserved for other tasks such as performing simulations, performing autonomy development/testing, performing characterization of hardware/software performance, generating additional artificial data, etc.

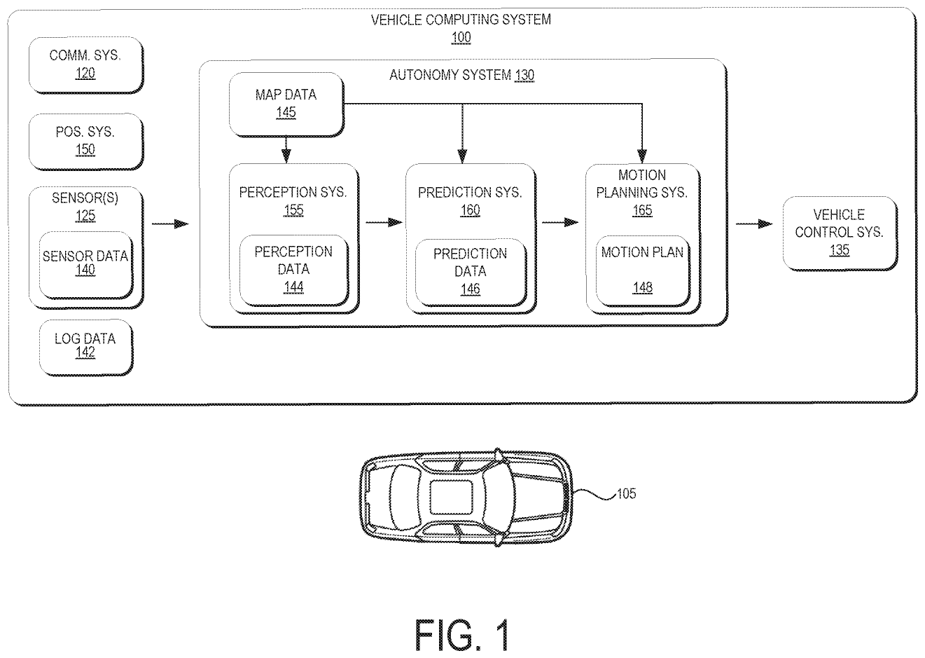

With reference now to the FIGS., example aspects of the present disclosure will be discussed in further detail. FIG. 1 illustrates an example vehicle computing system 100 according to example embodiments of the present disclosure. The vehicle computing system 100 can be associated with a vehicle 105. The vehicle computing system 100 can be located onboard (e.g., included on and/or within) the vehicle 105.

The vehicle 105 incorporating the vehicle computing system 100 can be various types of vehicles. The vehicle 105 can be autonomous vehicle. For instance, the vehicle 105 can be a ground-based autonomous vehicle such as an autonomous car, autonomous truck, autonomous bus, etc. The vehicle 105 can be an air-based autonomous vehicle (e.g., airplane, helicopter, or other aircraft) or other types of vehicles (e.g., watercraft, etc.). The vehicle 105 can drive, navigate, operate, etc. with minimal and/or no interaction from a human operator (e.g., driver). An operator (also referred to as a vehicle operator) can be included in the vehicle 105 and/or remote from the vehicle 105. In some implementations, the vehicle 105 can be a non-autonomous vehicle.

In some implementations, the vehicle 105 can be configured to operate in a plurality of operating modes. The vehicle 105 can be configured to operate in a fully autonomous (e.g., self-driving) operating mode in which the vehicle 105 is controllable without user input (e.g., can drive and navigate with no input from a vehicle operator present in the vehicle 105 and/or remote from the vehicle 105). The vehicle 105 can operate in a semi-autonomous operating mode in which the vehicle 105 can operate with some input from a vehicle operator present in the vehicle 105 (and/or a human operator that is remote from the vehicle 105). The vehicle 105 can enter into a manual operating mode in which the vehicle 105 is fully controllable by a vehicle operator (e.g., human driver, pilot, etc.) and can be prohibited and/or disabled (e.g., temporary, permanently, etc.) from performing autonomous navigation (e.g., autonomous driving). In some implementations, the vehicle 105 can implement vehicle operating assistance technology (e.g., collision mitigation system, power assist steering, etc.) while in the manual operating mode to help assist the vehicle operator of the vehicle 105.

The vehicle computing system 100 can include one or more computing devices located onboard the vehicle 105. For example, the computing device(s) can be located on and/or within the vehicle 105. The computing device(s) can include various components for performing various operations and functions. For instance, the computing device(s) can include one or more processors and one or more tangible, non-transitory, computer readable media (e.g., memory devices, etc.). The one or more tangible, non-transitory, computer readable media can store instructions that when executed by the one or more processors cause the vehicle 105 (e.g., its computing system, one or more processors, etc.) to perform operations and functions, such as those described herein.

In some implementations, the vehicle 105 can include a communications system 120 configured to allow the vehicle computing system 100 (and its computing device(s)) to communicate with other computing devices. The vehicle computing system 100 can use the communications system 120 to communicate with one or more computing device(s) that are remote from the vehicle 105 over one or more networks (e.g., via one or more wireless signal connections). In some implementations, the communications system 120 can allow communication among one or more of the system(s) on-board the vehicle 105. The communications system 120 can include any suitable components for interfacing with one or more network(s), including, for example, transmitters, receivers, ports, controllers, antennas, and/or other suitable components that can help facilitate communication.

In some implementations, the vehicle 105 can include one or more vehicle sensors 125, an autonomy system 130, one or more vehicle control systems 135, and other systems, as described herein. One or more of these systems can be configured to communicate with one another via a communication channel. The communication channel can include one or more data buses (e.g., controller area network (CAN)), on-board diagnostics connector (e.g., OBD-II), and/or a combination of wired and/or wireless communication links. The onboard systems can send and/or receive data, messages, signals, etc. amongst one another via the communication channel.

The vehicle sensor(s) 125 can be configured to acquire sensor data 140 (e.g., real-world sensor data). This can include sensor data associated with the surrounding environment of the vehicle 105. For instance, the vehicle sensor(s) 125 can acquire image and/or other data within a field of view of one or more of the vehicle sensor(s) 125. The vehicle sensor(s) 125 can include a Light Detection and Ranging (LIDAR) system, a Radio Detection and Ranging (RADAR) system, one or more cameras (e.g., visible spectrum cameras, infrared cameras, etc.), motion sensors, and/or other types of imaging capture devices and/or sensors. The sensor data 140 can include image data, radar data, LIDAR data, and/or other data acquired by the vehicle sensor(s) 125. The vehicle 105 can also include other sensors configured to acquire data associated with the vehicle 105. For example, the vehicle 105 can include inertial measurement unit(s), wheel odometry devices, and/or other sensors.

In some implementations, the sensor data 140 can be indicative of one or more objects within the surrounding environment of the vehicle 105. In some implementations, the sensor data 140 can be indicative of one or more objects within one or more environments associated with the vehicle 105 (e.g., a surrounding environment of the vehicle 105 at one or more previous times). The sensor data 140 can include information that describes a location of the one or more objects within the one or more environments at one or more times. The object(s) can include, for example, vehicles, pedestrians, bicycles, and/or other objects. The object(s) can be located in front of, to the rear of, to the side of the vehicle 105, etc. The sensor data 140 can be indicative of locations associated with the object(s) within the surrounding environment of the vehicle 105 at one or more times. The vehicle sensor(s) 125 can provide the sensor data 140 to the autonomy system 130.

In some implementations, in addition to the sensor data 140, the autonomy system 130 can retrieve or otherwise obtain map data 145. The map data 145 can provide information about the surrounding environment of the vehicle 105. In some implementations, the map data 145 can provide information about one or more environments including the surrounding environment of the vehicle 105, and can provide information about one or more objects in the one or more environments. In some implementations, a vehicle 105 can obtain detailed map data that provides information regarding: the identity and location of different roadways, road segments, buildings, or other items or objects (e.g., lampposts, crosswalks, curbing, etc.); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, or other traffic control devices); the location of obstructions (e.g., roadwork, accidents, etc.); data indicative of events (e.g., scheduled concerts, parades, etc.); and/or any other map data that provides information that assists the vehicle 105 in comprehending and perceiving its surrounding environment and its relationship thereto. In some implementations, the vehicle computing system 100 can determine a vehicle route for the vehicle 105 based at least in part on the map data 145.

In some implementations, the vehicle 105 can include a positioning system 150. The positioning system 150 can determine a current position of the vehicle 105. The positioning system 150 can be any device or circuitry for analyzing the position of the vehicle 105. For example, the positioning system 150 can determine position by using one or more of inertial sensors (e.g., inertial measurement unit(s), etc.), a satellite positioning system, based on IP address, by using triangulation and/or proximity to network access points or other network components (e.g., cellular towers, WiFi access points, etc.) and/or other suitable techniques. The position of the vehicle 105 can be used by various systems of the vehicle computing system 100 and/or provided to a remote computing system. For example, the map data 145 can provide the vehicle 105 relative positions of the elements of a surrounding environment of the vehicle 105. The vehicle 105 can identify its position within the surrounding environment (e.g., across six axes, etc.) based at least in part on the map data 145. For example, the vehicle computing system 100 can process the sensor data 140 (e.g., LIDAR data, camera data, etc.) to match it to a map of the surrounding environment to get an understanding of the vehicle's position within that environment.

In some implementations, the autonomy system 130 can include a perception system 155, a prediction system 160, a motion planning system 165, and/or other systems that cooperate to perceive the surrounding environment of the vehicle 105 and determine a motion plan for controlling the motion of the vehicle 105 accordingly. For example, the autonomy system 130 can obtain the sensor data 140 from the vehicle sensor(s) 125, process the sensor data 140 (and/or other data) to perceive its surrounding environment, predict the motion of objects within the surrounding environment, and generate an appropriate motion plan through such surrounding environment. The autonomy system 130 can communicate with the one or more vehicle control systems 135 to operate the vehicle 105 according to the motion plan.

The vehicle computing system 100 (e.g., the autonomy system 130) can identify one or more objects that are proximate to the vehicle 105 based at least in part on the sensor data 140 and/or the map data 145. For example, the vehicle computing system 100 (e.g., the perception system 155) can process the sensor data 140, the map data 145, etc. to obtain perception data 144. The vehicle computing system 100 can generate perception data 144 that is indicative of one or more states (e.g., current and/or past state(s)) of a plurality of objects that are within a surrounding environment of the vehicle 105. For example, the perception data 144 for each object can describe (e.g., for a given time, time period) an estimate of the object's: current and/or past location (also referred to as position); current and/or past speed/velocity; current and/or past acceleration; current and/or past heading; current and/or past orientation; size/footprint (e.g., as represented by a bounding shape); class (e.g., pedestrian class vs. vehicle class vs. bicycle class), the uncertainties associated therewith, and/or other state information. The perception system 155 can provide the perception data 144 to the prediction system 160, the motion planning system 165, and/or other system(s).

The prediction system 160 can be configured to predict a motion of the object(s) within the surrounding environment of the vehicle 105. For instance, the prediction system 160 can generate prediction data 146 associated with such object(s). The prediction data 146 can be indicative of one or more predicted future locations of each respective object. For example, the prediction system 160 can determine a predicted motion trajectory along which a respective object is predicted to travel over time. A predicted motion trajectory can be indicative of a path that the object is predicted to traverse and an associated timing with which the object is predicted to travel along the path. The predicted path can include and/or be made up of a plurality of way points. In some implementations, the prediction data 146 can be indicative of the speed and/or acceleration at which the respective object is predicted to travel along its associated predicted motion trajectory. The prediction system 160 can output the prediction data 146 (e.g., indicative of one or more of the predicted motion trajectories) to the motion planning system 165.

The vehicle computing system 100 (e.g., the motion planning system 165) can determine a motion plan 148 for the vehicle 105 based at least in part on the perception data 144, the prediction data 146, and/or other data. A motion plan 148 can include vehicle actions (e.g., planned vehicle trajectories, speed(s), acceleration(s), other actions, etc.) with respect to one or more of the objects within the surrounding environment of the vehicle 105 as well as the objects' predicted movements. For instance, the motion planning system 165 can implement an optimization algorithm, model, etc. that considers cost data associated with a vehicle action as well as other objective functions (e.g., cost functions based on speed limits, traffic lights, etc.), if any, to determine optimized variables that make up the motion plan 148. The motion planning system 165 can determine that the vehicle 105 can perform a certain action (e.g., pass an object, etc.) without increasing the potential risk to the vehicle 105 and/or violating any traffic laws (e.g., speed limits, lane boundaries, signage, etc.). For instance, the motion planning system 165 can evaluate one or more of the predicted motion trajectories of one or more objects during its cost data analysis as it determines an optimized vehicle trajectory through the surrounding environment. The motion planning system 165 can generate cost data associated with such trajectories. In some implementations, one or more of the predicted motion trajectories may not ultimately change the motion of the vehicle 105 (e.g., due to an overriding factor). In some implementations, the motion plan 148 may define the vehicle's motion such that the vehicle 105 avoids the object(s), reduces speed to give more leeway to one or more of the object(s), proceeds cautiously, performs a stopping action, etc.

The motion planning system 165 can be configured to continuously update the vehicle's motion plan 148 and a corresponding planned vehicle motion trajectory. For example, in some implementations, the motion planning system 165 can generate new motion plan(s) for the vehicle 105 (e.g., multiple times per second). Each new motion plan can describe a motion of the vehicle 105 over the next planning period (e.g., next several seconds). Moreover, a new motion plan may include a new planned vehicle motion trajectory. Thus, in some implementations, the motion planning system 165 can continuously operate to revise or otherwise generate a short-term motion plan based on the currently available data. Once the optimization planner has identified the optimal motion plan (or some other iterative break occurs), the optimal motion plan (and the planned motion trajectory) can be selected and executed by the vehicle 105.

The vehicle computing system 100 can cause the vehicle 105 to initiate a motion control in accordance with at least a portion of the motion plan 148. A motion control can be an operation, action, etc. that is associated with controlling the motion of the vehicle. For instance, the motion plan 148 can be provided to the vehicle control system(s) 135 of the vehicle 105. The vehicle control system(s) 135 can be associated with a vehicle controller (e.g., including a vehicle interface) that is configured to implement the motion plan 148. The vehicle controller can, for example, translate the motion plan into instructions for the appropriate vehicle control component (e.g., acceleration control, brake control, steering control, etc.). By way of example, the vehicle controller can translate a determined motion plan 148 into instructions to adjust the steering of the vehicle 105 “X” degrees, apply a certain magnitude of braking force, etc. The vehicle controller (e.g., the vehicle interface) can help facilitate the responsible vehicle control (e.g., braking control system, steering control system, acceleration control system, etc.) to execute the instructions and implement the motion plan 148 (e.g., by sending control signal(s), making the translated plan available, etc.). This can allow the vehicle 105 to autonomously travel within the vehicle's surrounding environment.

In some implementations, the vehicle computing system 100 can be configured to acquire log data 142 (e.g., real-world log data). This can include log data associated with one or more systems and/or devices onboard an autonomous vehicle. For instance, the log data 142 can include state information and/or diagnostics information associated with one or more systems and/or devices onboard the vehicle 105 (e.g., communications system 120, vehicle sensor(s) 125, autonomy system 130, vehicle control system(s) 135, positioning system 150, perception system 155, prediction system 160, motion planning system 165, and/or other systems).

Although many examples are described herein with respect to autonomous vehicles, the disclosed technology is not limited to autonomous vehicles. Any vehicle may utilize the technology described herein for obtaining real-world data. For example, a non-autonomous vehicle may utilize aspects of the present disclosure to obtain real-world sensor data and/or real-world log data.

An artificial scenario computing system can obtain the real-world data (e.g., map data, sensor data, log data, etc.) to generate artificial data representing one or more artificial environments and/or one or more artificial logs.

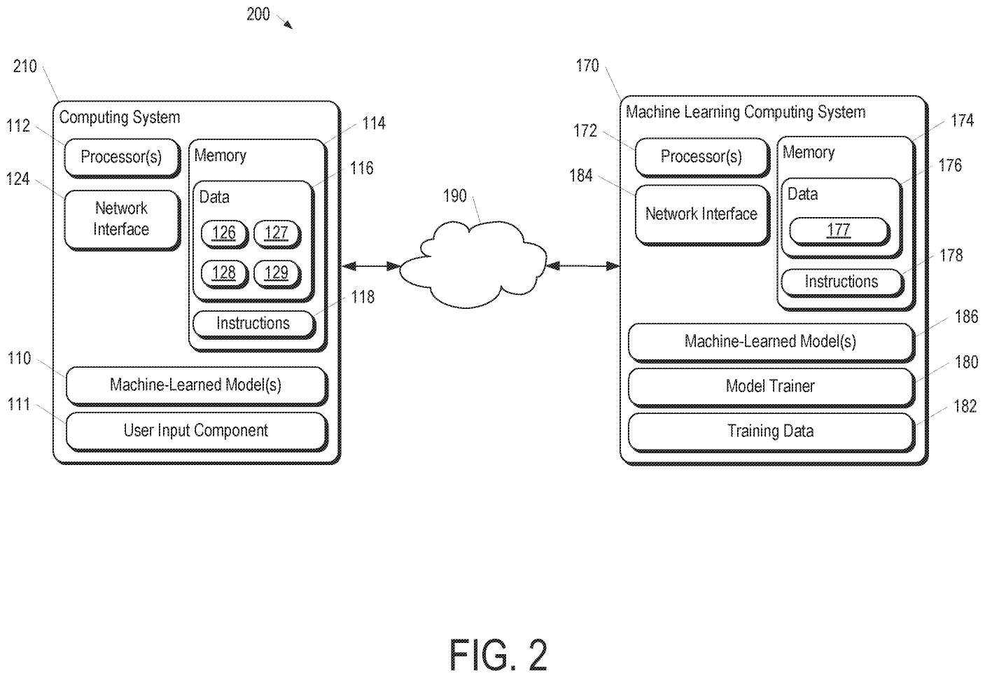

FIG. 2 depicts a block diagram of an example artificial scenario computing system 200 according to example embodiments of the present disclosure. The example system 200 includes a computing system 210 and a machine learning computing system 170 that are communicatively coupled over a network 190.

In some implementations, the computing system 210 can generate artificial scenarios. In some implementations, the computing system 210 can be included in an autonomous vehicle. For example, the computing system 210 can be on-board the autonomous vehicle. In other implementations, the computing system 210 is not located on-board the autonomous vehicle. For example, the computing system 210 can operate offline to generate artificial scenarios. The computing system 210 can include one or more distinct physical computing devices.

The computing system 210 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage media, such as RAM, ROM, EEPROM, EPROM, one or more memory devices, flash memory devices, etc., and combinations thereof.

The memory 114 can store information that can be accessed by the one or more processors 112. For instance, the memory 114 (e.g., one or more non-transitory computer-readable storage mediums, memory devices) can store data 116 that can be obtained, received, accessed, written, manipulated, created, and/or stored. The data 116 can include, for instance, parameter input data 126, variance input data 127, artificial data 128, authenticity data 129, and/or other data as described herein. In some implementations, the computing system 210 can obtain data from one or more memory device(s) that are remote from the system 210.

The parameter input data 126 can include one or more parameters for generating the artificial data 128. In particular, the parameter input data 126 can be used by the machine-learned model(s) 110 to generate the artificial data 128. The parameter input data 126 can include environment parameter data representing one or more parameters for generating one or more artificial environments, and/or log parameter data representing one or more parameters for generating one or more artificial logs.

The environment parameter data can include, for example, one or more parameters that indicate an environment locale (e.g., urban, suburban, rural, etc.), one or more travel ways and their characteristics (e.g., position, orientation, direction of traffic, number of lanes, traffic speed, etc.), one or more objects (e.g., vehicles, bicycles, pedestrians, buildings, barriers, obstacles, etc.) and their characteristics (e.g., type, properties, position, path, etc.).

The log parameter data can include, for example, a target object for which to generate artificial log data (e.g., sensor system log, autonomy system log, vehicle control system log, communications log, etc.), a position of the object, an orientation of the object, a time-window for the artificial log data, etc.

The variance input data 127 can include one or more variance threshold values for one or more parameters in the parameter input data 126. In particular, the parameter input data 126 and variance input data 127 can be used by the machine-learned model(s) 110 to generate the artificial data 128. The variance input data 127 can include environment variance data associated with the environment parameter data and/or log variance data associated with the log parameter data. The environment variance data can represent one or more variance threshold values for one or more parameters in the environment parameter data. The log variance data can represent one or more variance threshold values for one or more parameters in the log parameter data.

The artificial data 128 can include one or more artificial environments and/or artificial logs based at least in part on generator input data (e.g., parameter input data 126 and variance input data 127). The generator input data can be used by the machine-learned model(s) 110 to generate the artificial data 128.

The authenticity data 129 can include an authenticity associated with each parameter used to generate the artificial data 128 and/or determine an overall authenticity associated with the artificial data 128. The authenticity data 129 can be used by the machine-learned model(s) 110 to generate new artificial data and/or to select one or more artificial scenarios from the artificial data 128.

In some implementations, the computing system 210 can obtain generator input data (e.g., parameter input data 126 and/or variance input data 127) based at least in part on an input from a user, predetermined input data, and/or existing artificial data. As an example, a user can input generator input data via the user input component 111 connected to the computing system 210. The data input by the user can specify one or more parameters and associated variance values for one or more artificial environments and/or artificial logs that are desired by the user. As another example, a user can direct the computing system 210 to obtain predetermined input data from a local or remote memory location. The predetermined input data can include one or more parameters and associated variance values for one or more artificial environments and/or artificial logs. As another example, the computing system 210 can obtain existing artificial data. The existing artificial data can represent previously generated artificial data (e.g., one or more previously generated artificial environments and/or artificial logs). The computing system 210 can extract generator input data (e.g., parameter input data 126, variance input data 127) from the existing artificial data that was used to generate the existing artificial data.

The memory 114 can also store computer-readable instructions 118 that can be executed by the one or more processors 112. The instructions 118 can be software written in any suitable programming language or can be implemented in hardware. Additionally, or alternatively, the instructions 118 can be executed in logically and/or virtually separate threads on processor(s) 112.

For example, the memory 114 can store instructions 118 that when executed by the one or more processors 112 cause the one or more processors 112 to perform any of the operations and/or functions described herein, including, for example, generating artificial data 128 representing one or more artificial scenarios, generating authenticity data 129 associated with the one or more artificial scenarios, and selecting an artificial scenario from the artificial data 128 based at least in part on the authenticity data 129.

According to an aspect of the present disclosure, the computing system 210 can store or include one or more machine-learned models 110. As examples, the machine-learned models 110 can be or can otherwise include various machine-learned models such as, for example, neural networks (e.g., deep neural networks), support vector machines, decision trees, ensemble models, k-nearest neighbors models, Bayesian networks, or other types of models including linear models and/or non-linear models. Example neural networks include feed-forward neural networks, recurrent neural networks (e.g., long short-term memory recurrent neural networks), convolutional neural networks, or other forms of neural networks.

In some implementations, the computing system 210 can receive the one or more machine-learned models 110 from the machine learning computing system 170 over network(s) 190 and can store the one or more machine-learned models 110 in the memory 114. The computing system 210 can then use or otherwise implement the one or more machine-learned models 110 (e.g., by processor(s) 112). In particular, the computing system 210 can implement the machine learned model(s) 110 to generate artificial scenarios.

The machine learning computing system 170 includes one or more processors 172 and a memory 174. The one or more processors 172 can be any suitable processing device (e.g., a processor core, a microprocessor, an ASIC, a FPGA, a controller, a microcontroller, etc.) and can be one processor or a plurality of processors that are operatively connected. The memory 174 can include one or more non-transitory computer-readable storage media, such as RAM, ROM, EEPROM, EPROM, one or more memory devices, flash memory devices, etc., and combinations thereof.

The memory 174 can store information that can be accessed by the one or more processors 172. For instance, the memory 174 (e.g., one or more non-transitory computer-readable storage mediums, memory devices) can store data 176 that can be obtained, received, accessed, written, manipulated, created, and/or stored. The data 176 can include, for instance, real-world data 177, and/or other data as described herein. In some implementations, the machine learning computing system 170 can obtain data from one or more memory device(s) that are remote from the system 170. In some implementations, at least a portion of the real-world data 177 can be acquired by the vehicle 105 operating in the real-world. For instance, as described herein, the vehicle 105 can include sensor(s) 125 that can obtain sensor data 140, vehicle computing system 100 that can generate or otherwise obtain log data 142, and autonomy system 130 that can retrieve or otherwise obtain map data 145. The computing system 210 can obtain the real-world data 177 from the vehicle computing system 100. For example, the computing system 210 can obtain the sensor data 140, log data 142, and/or map data 145 from the vehicle computing system 100 onboard the vehicle 105, which can be and/or otherwise be included in the real-world data 177.

In some implementations, the real-world data 177 can be human-labeled and/or machine labelled to indicate one or more classifications, characteristics, and/or properties associated with one or more objects represented by the real-world data 177. The labeled real-world data 177 can be used to train the machine-learned model(s) 110, 186 (e.g., general adversarial network (GAN) models) that can be used to generate artificial data. The machine-learned model(s) 110, 186 can include one or more machine-learned generator models that can generate the artificial data 128, and one or more machine-learned discriminator models that can authenticate the artificial data (e.g., to determine whether the artificial data is representative of a real-world scenario). The real-world data 177 can be used to train the machine-learned generator model(s) and/or the machine-learned discriminator model(s) associated with the machine-learned model(s) 110, 186. For example, the labeled real-world data 177 can be utilized as ground-truth data to determine the accuracy and/or development of the machine-learned model(s) 110, 186 as during training. By training the machine-learned model(s) 110, 186 using the real-world data 177, it is possible to generate high quality artificial data (e.g., for measurement, development, testing, etc.).

The memory 174 can also store computer-readable instructions 178 that can be executed by the one or more processors 172. The instructions 178 can be software written in any suitable programming language or can be implemented in hardware. Additionally, or alternatively, the instructions 178 can be executed in logically and/or virtually separate threads on processor(s) 172.

For example, the memory 174 can store instructions 178 that when executed by the one or more processors 172 cause the one or more processors 172 to perform any of the operations and/or functions described herein, including, for example, generating artificial data representing one or more artificial scenarios, generating authenticity data associated with the one or more artificial scenarios, training model(s) (e.g., GAN model(s), etc.) and selecting an artificial scenario from the one or more artificial scenarios based at least in part on the authenticity data.

In some implementations, the machine learning computing system 170 includes one or more server computing devices. If the machine learning computing system 170 includes multiple server computing devices, such server computing devices can operate according to various computing architectures, including, for example, sequential computing architectures, parallel computing architectures, or some combination thereof.

In addition or alternatively to the model(s) 110 at the computing system 210, the machine learning computing system 170 can include one or more machine-learned models 186. As examples, the machine-learned models 186 can be or can otherwise include various machine-learned models such as, for example, neural networks (e.g., deep neural networks), support vector machines, decision trees, ensemble models, k-nearest neighbors models, Bayesian networks, or other types of models including linear models and/or non-linear models. Example neural networks include feed-forward neural networks, recurrent neural networks (e.g., long short-term memory recurrent neural networks), convolutional neural networks, or other forms of neural networks. The machine-learned models 186 can include the model(s) 110.

As an example, the machine learning computing system 170 can communicate with the computing system 210 according to a client-server relationship. For example, the machine learning computing system 170 can implement the machine-learned models 186 to provide a web service to the computing system 210. For example, the web service can generate artificial scenarios.

Thus, machine-learned models 110 can located and used at the computing system 210 and/or machine-learned models 186 can be located and used at the machine learning computing system 170.

In some implementations, the machine learning computing system 170 and/or the computing system 210 can train the machine-learned models 110 and/or 186 through use of a model trainer 180. The model trainer 180 can train the machine-learned models 110 and/or 186 using one or more training or learning algorithms. One example training technique is backwards propagation of errors. In some implementations, the model trainer 180 can perform supervised training techniques using a set of labeled training data. In other implementations, the model trainer 180 can perform unsupervised training techniques using a set of unlabeled training data. The model trainer 180 can perform a number of generalization techniques to improve the generalization capability of the models being trained. Generalization techniques include weight decays, dropouts, or other techniques.

In particular, the model trainer 180 can train a machine-learned model 110 and/or 186 based on a set of training data 182. The training data 182 can include, for example, the real-world data 177. The model trainer 180 can be implemented in hardware, firmware, and/or software controlling one or more processors.

The computing system 210 can also include a network interface 124 used to communicate with one or more systems or devices, including systems or devices that are remotely located from the computing system 210. The network interface 124 can include any circuits, components, software, etc. for communicating with one or more networks (e.g., 190). In some implementations, the network interface 124 can include, for example, one or more of a communications controller, receiver, transceiver, transmitter, port, conductors, software and/or hardware for communicating data. Similarly, the machine learning computing system 170 can include a network interface 164.

The network(s) 190 can be any type of network or combination of networks that allows for communication between devices. In some embodiments, the network(s) can include one or more of a local area network, wide area network, the Internet, secure network, cellular network, mesh network, peer-to-peer communication link and/or some combination thereof and can include any number of wired or wireless links. Communication over the network(s) 190 can be accomplished, for instance, via a network interface using any type of protocol, protection scheme, encoding, format, packaging, etc.

FIG. 2 illustrates one example computing system 200 that can be used to implement the present disclosure. Other computing systems can be used as well. For example, in some implementations, the computing system 210 can include the model trainer 180 and the training dataset 182. In such implementations, the machine-learned models 110 can be both trained and used locally at the computing system 210. As another example, in some implementations, the computing system 210 is not connected to other computing systems.

In addition, components illustrated and/or discussed as being included in one of the computing systems 210 or 170 can instead be included in another of the computing systems 210 or 170. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

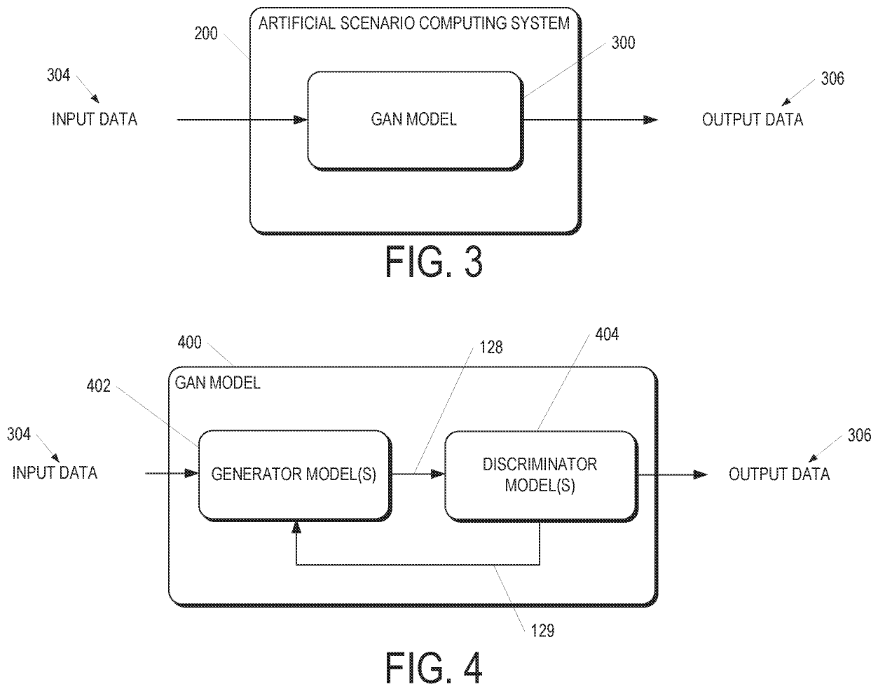

FIG. 3 depicts a block diagram of an example GAN model 300 according to example embodiments of the present disclosure. In some implementations, the GAN model 300 is trained to receive a set of input data 304 (e.g., generator input data) representing one or more parameters (e.g., parameter input data 126) and one or more variance threshold values (e.g., variance input data 127) for generating the artificial data 128 including one or more artificial scenarios and, as a result of receipt of the input data 304, provide output data 306 that includes a selection of one or more artificial scenarios from the artificial data 128. For instance, this can be accomplished via the use of one or more generator model(s) and discriminator model(s), as further described herein.

FIG. 4 depicts a block diagram of an example GAN model 400 according to example embodiments of the present disclosure. The GAN model 400 is similar to GAN model 300 of FIG. 3 except that GAN model 400 further includes one or more machine-learned generator models 402 and one or more machine-learned discriminator models 404. The machine-learned generator model(s) 402 is trained to receive the set of input data 304, and as a result of receipt of the input data 304, provide artificial data 128 that includes the one or more artificial scenarios. The machine-learned discriminator model(s) 404 is trained to receive the artificial data 128, and as a result of receipt of the artificial data 128, provide the output data 306 and/or the authenticity data 129.

In some implementations, the machine-learned generator model(s) 402 can be configured to receive environment parameter data and associated environment variance data. In response, the machine-learned generator model(s) 402 can generate artificial data 128 that includes one or more artificial environments based on the environment parameter data and environment variance data. In some implementations, the machine-learned generator model(s) 402 can be configured to receive log parameter data and associated log variance data. In response, the machine-learned generator model(s) 402 can generate artificial data 128 that includes one or more artificial logs based on the log parameter data and log variance data. In some implementations, the machine-learned generator model(s) 402 can be configured to receive existing artificial data. In response, the machine-learned generator model(s) 402 can generate artificial data 128 that includes one or more artificial environments and/or artificial logs based on generator input data extracted from the existing artificial data.

In some implementations, the machine-learned discriminator model(s) 404 is trained to receive the artificial data 128, and as a result of receipt of the artificial data 128, determine authenticity data 129 that represents an authenticity associated with each parameter used to generate the artificial data 128 and/or an overall authenticity associated with the artificial data 128. The machine-learned discriminator model(s) 404 can provide the output data 306 that includes a selection of one or more artificial scenarios from the artificial data 128, based at least in part on the authenticity data 129 (e.g., by selecting the one or more artificial scenarios from the artificial data 128 such that the artificial scenario(s) are associated with an authenticity that exceeds a minimum authenticity threshold).

In some implementations, the machine-learned discriminator model(s) 404 can be trained to receive the artificial data 128, and as a result of receipt of the artificial data 128, provide the authenticity data 129 to the machine-learned generator model(s) 402. The authenticity data 129 can be provided as a feedback from the machine-learned discriminator model(s) 404 so that the machine-learned generator model(s) 402 can generate additional artificial data 128 based at least in part on the authenticity data 129. The machine-learned generator model(s) 402 can be trained to receive input data 304 (e.g., existing artificial data) and the authenticity data 129, and as a result of receipt of the input data 304 and authenticity data 129, provide the artificial data 128 that includes one or more artificial scenarios based at least in part on the authenticity data 129. In this way, after each feedback iteration, the artificial data 128 output by the machine-learned generator model(s) 402 can include one or more artificial scenarios that are more likely to be determined as authentic than an artificial scenario that was output during a previous iteration. In some implementations (e.g., after a plurality of feedback iterations), the machine-learned generator model(s) 402 can directly output the artificial data 128 as output data 306 (e.g., without the use of discriminator model(s) 404). For example, (e.g., during a first feedback iteration), the machine-learned generator model(s) 402 can output artificial data 128 including one or more first artificial scenarios, and the machine-learned discriminator model(s) 404 can output authenticity data 129 based at least in part on the one or more first artificial scenarios. The authenticity data 129 can indicate that the one or more first artificial scenarios exceed an authenticity threshold value, and the machine-learned discriminator model(s) 404 can provide the authenticity data 129 to the machine-learned generator model(s) 402 for a second feedback iteration. During the second feedback iteration, the machine-learned generator model(s) 402 can output artificial data 128 that includes one or more second artificial scenarios that are more likely to be determined as authentic than the one or more first artificial scenarios and also exceed the authenticity threshold value. Since the one or more second artificial scenarios are determined to exceed the authenticity threshold value, the machine-learned generator model(s) 402 can directly output the one or more second artificial scenarios as output data 306.

In some implementations, the machine-learned discriminator model(s) 404 can be configured to receive the artificial data 128 and real-world data 177. In response, the machine-learned discriminator model(s) 404 can generate authenticity data 129 associated with the artificial data 128, based on the real-world data 177. As an example, the machine-learned discriminator model(s) 142 can determine an authenticity associated with each parameter used to generate the artificial data 128 and/or determine an overall authenticity associated with the artificial data 128, based on the real-world data 177. The machine-learned discriminator model(s) 404 can determine the authenticity data 129 based on the authenticity for each parameter and/or the overall authenticity.

In some implementations, the machine-learned generator model(s) 402 can be configured to receive existing artificial data and associated authenticity data. In response, the machine-learned generator model(s) 402 can generate artificial data 128 that includes one or more artificial environments and/or artificial logs based on generator input data extracted from the existing artificial data and the authenticity data associated with the existing artificial data. The authenticity data associated with the existing artificial data can include artificial environment authenticity data associated with an artificial environment (e.g., how well the artificial environment represents a real-world environment) and/or artificial log authenticity data associated with an artificial log (e.g., how well the artificial log represents a real-world log).

As an example, in response to receiving artificial environment authenticity data associated with a previously generated first artificial environment, the machine-learned generator model(s) 402 can generate a second artificial environment that augments the first artificial environment based on the artificial environment authenticity data such that the second artificial environment is likely to be determined as more authentic than the first artificial environment.

As another example, in response to receiving artificial log authenticity data associated with a previously generated first artificial log, the machine-learned generator model(s) 402 can generate a second artificial log that augments the first artificial log based on the artificial log authenticity data such that the second artificial environment is likely to be determined as more authentic than the first artificial log.

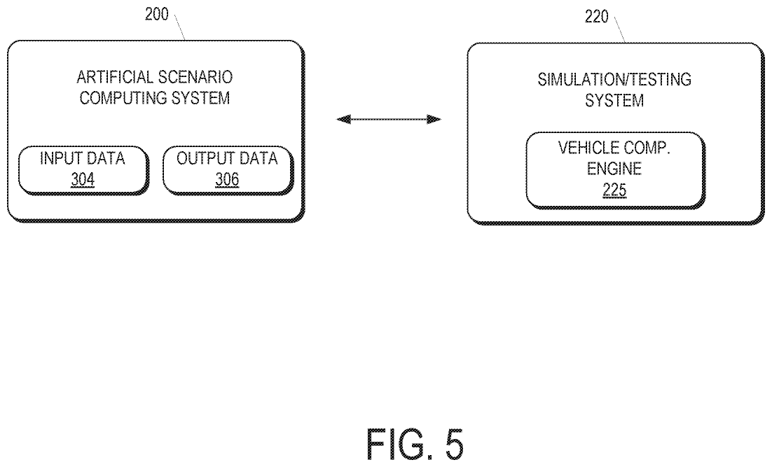

FIG. 5 depicts an example artificial scenario computing system 200 according to example embodiments of the present disclosure. To help improve system functionality and software capabilities, vehicle computing system functionality can be tested in an offline, simulated environment. The computing system 200 can include the model(s) 300/400. The computing system 200 can generate the artificial data 128 based at least in part on real-world data 177 (e.g., sensor data 140, log data 142, map data 145, etc.) obtained from the vehicle computing system 100. The computing system 200 can generate the output data 306 that includes one or more artificial scenarios (e.g., artificial environment(s) and/or artificial log(s)) for simulation and/or testing based at least in part on the artificial data 128 (e.g., that passes the authenticity analysis of the discriminator model(s) 404). The computing system 200 can include one or more computing devices. The computing device(s) can include various components for performing various operations and functions. For instance, the computing device(s) can include one or more processors and one or more tangible, non-transitory, computer readable media (e.g., memory devices, etc.). The one or more tangible, non-transitory, computer readable media can store instructions that when executed by the one or more processors cause the computing system 200 (e.g., its one or more processors, etc.) to perform operations and functions, such as those described herein.

In some implementations, the computing system 200 can provide the artificial data 128 to a simulation/testing system 220 (included and/or separate from the computing system 200) configured to perform a simulation based at least in part on the artificial data. The simulation/testing system 220 can include one or more computing devices. The computing device(s) can include various components for performing various operations and functions. For instance, the computing device(s) can include one or more processors and one or more tangible, non-transitory, computer readable media (e.g., memory devices, etc.). The one or more tangible, non-transitory, computer readable media can store instructions that when executed by the one or more processors cause the simulation/testing system 220 (e.g., its one or more processors, etc.) to perform operations and functions, such as those described herein.

As an example, the computing system 200 can provide artificial data representing an artificial environment to the simulation/testing system 220, and the simulation/testing system 220 can perform a simulation based at least in part on the artificial environment. In particular, the simulation/testing system 220 can create a virtual world based at least in part on the artificial data, and simulate a vehicle 105 in the virtual world to measure vehicle system performance of the vehicle 105. As another example, the computing system 200 can provide artificial data representing an artificial log to the simulation/testing system 220, and the simulation/testing system 220 can perform development, testing, and/or characterization of one or more hardware and/or software components.

In some implementations, the simulation/testing system 220 can access and/or otherwise leverage a vehicle computing engine 225. The vehicle computing engine 225 can be a computing system (with one or more processor(s) and one or more memory) configured to evaluate the performance of an autonomous vehicle. The vehicle computing engine 225 can be programmed based at least in part on one or more software stacks that are the same as or at least similar to the software stack utilized on an autonomous vehicle (e.g., outside of a testing environment). The software stack(s) can include, for example, a sensor software stack, autonomy software stack, vehicle control software stack, communications software stack, and/or another software stack. The software stack(s) utilized in the vehicle computing engine 225 can also, or alternatively, include software (e.g., an updated version) that has not been deployed onto an autonomous vehicle 105 (e.g., a software version associated with a newly developed vehicle capability). The vehicle computing engine 225 utilized in the simulation/testing system 220 can include the components like those of a vehicle computing system 100 that would be included in an autonomous vehicle 105 that is acting outside of a testing scenario (e.g., deployed in the real-world for a vehicle service). The vehicle computing engine 225 can be utilized to simulate the autonomous vehicle 105 in an artificial environment. The vehicle computing engine 225 can include various sub-systems that cooperate to perceive the artificial environment of a simulated autonomous vehicle, predict object motion, and determine a motion plan for controlling the motion of a simulated autonomous vehicle. For example, the vehicle computing engine 225 can acquire sensor data associated with a simulated environment, determine a motion plan for the simulated vehicle through its simulated environment based at least in part on the sensor data.

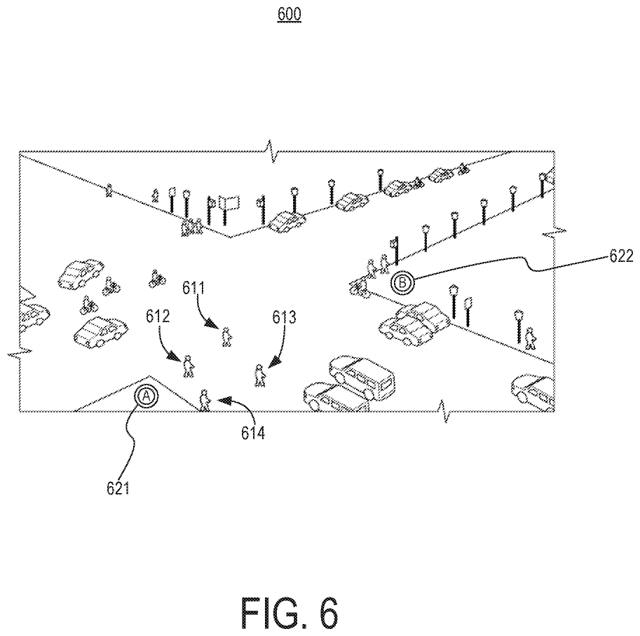

FIG. 6 depicts an example simulated environment 600, according to example embodiments of the present disclosure. The artificial scenario computing system 200 can obtain input data 304 that includes environment parameter data and environment variance data indicative of the simulated environment 600, and generate output data 306 that includes an artificial environment that can be simulated to create the simulated environment 600. The computing system 200 can simulate an autonomous vehicle in the simulated environment 600 to measure system performance of the vehicle.

As an example, the computing system 200 can obtain input data 304 that includes environment parameter data indicative of an intersection of two roads with vehicular traffic and pedestrians 611, 612, 613, and 614 that travel from a first location 621 (e.g., location “A”) to a second location 622 (e.g., location “B”) so as to cross one of the two roads. The computing system 200 can input the input data 304 into the GAN model 300/400 and, in response to the input data 304, obtain output data 306. The output data 306 can include at least a first artificial scenario that passes the authenticity analysis of the GAN model 300/400. The simulated environment based at least in part on the first artificial scenario can include the intersection of two roads with vehicular traffic and the four pedestrians 611, 612, 613, and 614 crossing a street.

As another example, the input data 304 can further include environment parameter data indicative of a start time for each of the pedestrians 611, 612, 613, and 614 to travel from the first location 621 to the second location 622, and environment variance data indicative of a variance threshold value for the start time corresponding to each of the pedestrians 611, 612, 613, and 614. If the start time for pedestrian 611 is t₀ with a variance threshold value of “+/−2 seconds,” then the start time for pedestrian 611 in the simulation 600 can be between “t₀−2 seconds” and “t₀+2 seconds.” If the start time for pedestrian 612 is t₀ with a variance threshold value of “+/−3 seconds,” then the start time for pedestrian 612 in the simulation 600 can be between “t₀−3 seconds” and “t₀+3 seconds.” If the start time for pedestrians 613 and 614 is t₁ with a variance threshold value of “+/−3 seconds,” then the start time for pedestrian 613 in the simulation 600 can be between “t₁−3 seconds” and “t₁+3 seconds,” and the start time for pedestrian 614 in the simulation 600 can be between “t₁−3 seconds” and “t₁+3 seconds.”

As another example, the input data 304 can further include environment parameter data indicative of a travel path for each of the pedestrians 611, 612, 613, and 614 to travel from the first location 621 to the second location 622, and environment variance data indicative of a variance threshold value for the travel path corresponding to each of the pedestrians 611, 612, 613, and 614. The computing system 200 can input the input data 304 into the GAN model 300/400 and, in response to the input data 304, obtain output data 306. The output data 306 can include. The output data 306 can include at least a first artificial scenario that passes the authenticity analysis of the GAN model 300/400. The simulated environment based at least in part on the first artificial scenario can include a different path from the first location 621 to the second location 622 for each of the pedestrians 611, 612, 613, and 614.

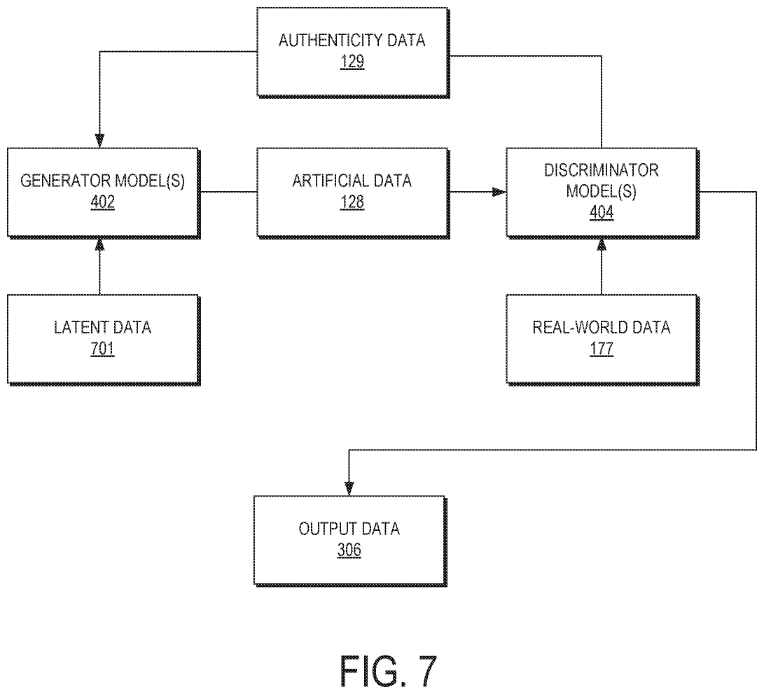

FIG. 7 depicts a block diagram of an example processing pipeline 700 associated with the artificial scenario computing system 200 according to an example embodiment of the present disclosure. For instance, the artificial scenario computing system 200 can obtain latent data 701. The latent data 701 can include, for example, the parameter input data 126 and variance input data 127 and input the latent data 701 into the machine-learned generator model(s) 402. In response to inputting the latent data 701, the machine-learned generator models 402 can output artificial data 128 based at least in part on the latent data 701. The artificial scenario computing system 200 can input the artificial data 128 into the machine-learned discriminator model(s) 404, and in response to inputting the artificial data 128, the machine-learned generator models 402 can output authenticity data 129 and/or output data 306. The artificial scenario computing system 200 can input the artificial data 129 into the machine-learned generator model(s) 402 as a feedback from the machine-learned discriminator models 404 so that the machine-learned generator model(s) 402 can generate additional artificial data 128 based at least in part on the authenticity data 129. The output data 306 can include one or more artificial scenarios from the artificial data 128 that are associated with an authenticity that is greater than a minimum threshold value. In some implementations, the artificial scenario computing system 200 can input real-world data 177 (e.g., sensor data 140, log data 142, map data 145, etc.) into the machine-learned discriminator model(s) 404, and in response to inputting the real-world data 177, the machine-learned discriminator model(s) 404 can provide the authenticity data 129 and/or output data 306 based at least in part on real-world data 177. For example, the machine-learned discriminator model(s) 404 can use the real-world data 177 to determine an authenticity associated with an artificial scenario, and/or the machine-learned model(s) 404 can use the real-world data 177 to determine an authenticity threshold value for the artificial scenario in order to determine the output data 306.

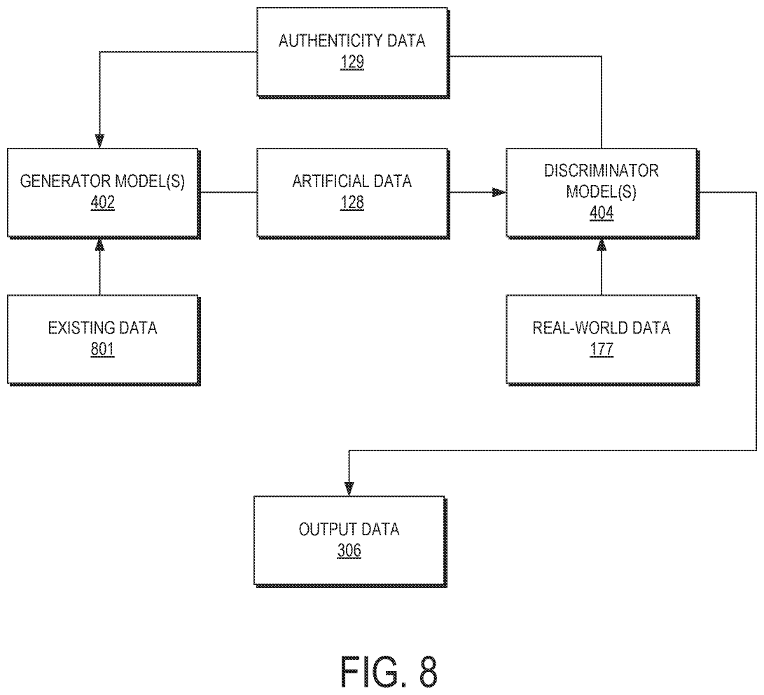

FIG. 8 depicts a block diagram of an example processing pipeline 800 associated with the artificial scenario computing system 200 according to an example embodiment of the present disclosure. For instance, the artificial scenario computing system 200 can obtain existing data 801. The existing data 801 can include, for example, previously generated artificial data. The artificial scenario computing system 200 can also obtain authenticity data 129 based at least in part on the existing data 801. The artificial scenario computing system 200 can input the existing data 801 and authenticity data 129 into the machine-learned generator model(s) 402, and in response, the machine-learned generator model(s) 402 can output artificial data 128 based at least in part on the authenticity data 129 and the existing data 801. The artificial scenario computing system 200 can input the artificial data 128 into the machine-learned discriminator model(s) 404, and in response to inputting the artificial data 128, the machine-learned generator models 402 can output authenticity data 129 and/or output data 306. The output data 306 can include one or more artificial scenarios from the artificial data 128 that are associated with an authenticity that is greater than a minimum threshold value. In some implementations, the artificial scenario computing system 200 can input real-world data 805 (e.g., sensor data 140, log data 142, map data 145, etc.) into the machine-learned discriminator models 404, and in response to inputting the real-world data 805, the machine-learned discriminator models 404 can provide the authenticity data 129 and/or output data 306 based at least in part on real-world data 805.

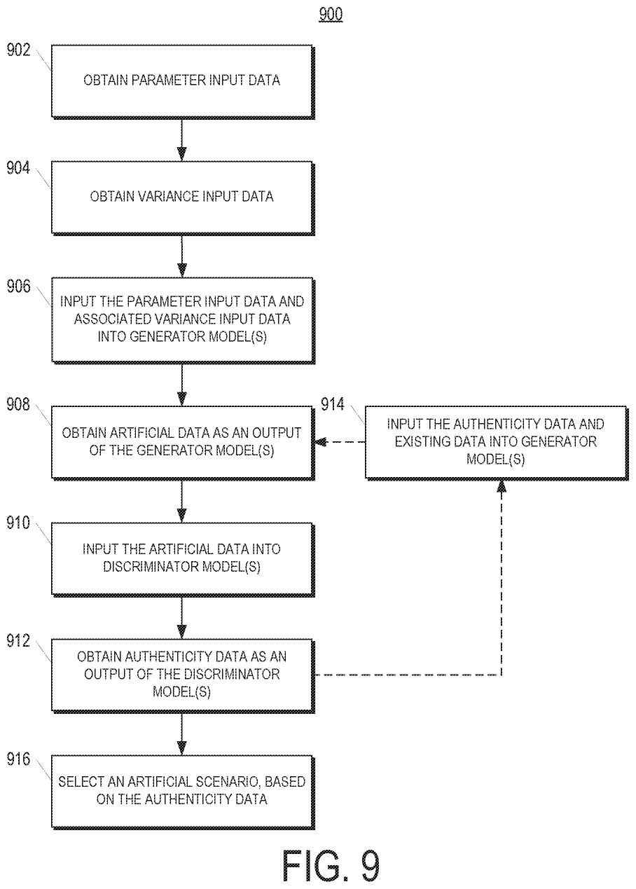

FIG. 9 depicts a flow diagram of an example method 900 for generating artificial scenarios according to example implementations of the present disclosure. One or more portion(s) of the method 900 can be can be implemented by a computing system that includes one or more computing devices such as, for example, the computing systems described with reference to the other figures (e.g., vehicle computing system 100, artificial scenario computing system 200, simulation/testing system 220, machine learning computing system 170, etc.). Each respective portion of the method 900 can be performed by any (or any combination) of one or more computing devices. Moreover, one or more portion(s) of the method 900 can be implemented as an algorithm on the hardware components of the device(s) described herein (e.g., as in FIGS. 1-5, 7-8, and/or 10), for example, to generate artificial data for autonomous vehicles. FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 9 is described with reference to elements/terms described with respect to other systems and figures for example illustrated purposes and is not meant to be limiting. One or more portions of method 900 can be performed additionally, or alternatively, by other systems.

At (902), the method 900 can include obtaining parameter input data (e.g., environment parameter data or log parameter data). For example, the artificial scenario computing system 200 can obtain generator input data indicative of one or more parameter values. The generator input data can include, for example, parameter input data 126. The parameter input data 126 can include environment parameter data and/or log parameter data.

At (904), the method 900 can include obtaining variance input data (e.g., environment variance data or log variance data). For example, the artificial scenario computing system 200 can obtain generator input data that includes the variance input data 127. The variance input data 127 can include one or more variance threshold values for one or more parameters in the parameter input data 126. In particular, the variance input data 127 can include environment variance data associated with the environment parameter data and/or log variance data associated with the log parameter data 126. The environment variance data can represent one or more variance threshold values for one or more parameters in the environment parameter data. The log variance data can represent one or more variance threshold values for one or more parameters in the log parameter data.

At (906), the method 900 can include inputting the parameter input data and the variance input data into one or more generator models. For example, the artificial scenario computing system 200 can input the generator input data into the machine-learned generator model(s) 402. In particular, the artificial scenario computing system 200 can input the environment parameter data and the environment variance data into the generator model(s) 402 and/or input the log parameter data and the log variance data into the generator model(s) 402. In some implementations, the machine-learned generator model(s) 402 is configured to generate artificial data 128 based at least in part on the parameter input data 128. In some implementations, the machine-learned generator model(s) 402 is configured to generate the artificial data 128 based at least in part on the parameter input data 128 and the variance input data 129. In some implementations, the machine-learned generator model(s) 402 is configured to generate the artificial data 128 based at least in part on the generator input data (e.g., parameter input data 128 and variance input data 129) and previously generated authenticity data associated with the generator input data. In some implementations, the machine-learned generator model(s) 402 can be trained based at least in part on real-world data 177.

At (908), the method 900 can include obtaining artificial data (e.g., artificial environment data or artificial log data) as an output of the generator model(s). For example, the artificial scenario computing system 200 can obtain an output of the machine-learned generator model(s) 402 in response to inputting the generator input data into the machine-learned generator model(s) 402. The machine-learned generator model(s) 402 can generate the output based at least in part on generator input data. The output can include artificial data 128 representing an artificial scenario associated with an autonomous vehicle. In some implementations, the artificial scenario is indicative of an artificial autonomous vehicle environment or artificial autonomous vehicle log data.

At (910), the method 900 can include inputting the artificial data into one or more discriminator models. For example, the artificial scenario computing system 200 can input the artificial data 128 into the machine-learned discriminator model(s) 404. In some implementations, the machine-learned discriminator model(s) 404 can be configured to generate authenticity data 129 based at least in part on the artificial data 128. In some implementations, the machine-learned discriminator model(s) 406 can be trained based at least in part on real-world data, as described herein.

At (912), the method 900 can include obtaining authenticity data as an output of the discriminator model(s). For example, the artificial scenario computing system 200 can obtain an output of the machine-learned discriminator model(s) 404 in response to inputting the artificial data 128 into the machine-learned discriminator model(s) 404. The machine-learned discriminator model(s) 404 can generate the output based at least in part on the artificial data 128. The output can include authenticity data 129 representing an authenticity associated with the artificial scenario in the artificial data 128, as described herein.

At (914), the method 900 can include inputting a previously generated artificial scenario and the authenticity data into the generator model(s). For example, the artificial scenario computing system 200 can input existing artificial data (e.g., a previously generated artificial scenario and an associated authenticity) into the generator model(s) 402. In some implementations, the machine-learned generator model(s) 402 can be configured to generate the artificial data 128 based at least in part on the previously generated artificial scenario and previously generated authenticity data associated with the previously generated artificial scenario. The generator model(s) 402 can generate the artificial data 128 based at least in part on the existing artificial data such that it is more likely to be determined as authentic compared to the previously generated artificial scenario. In some implementations, the generator model(s) 402 can be configured to generate the artificial data 128 based at least in part on previously generated authenticity data 129 associated with the previously generated artificial scenario. In some implementations, the generator model(s) 402 can be configured to adjust one or more parameter values associated with the previously generated artificial scenario to generate the artificial scenario that is based at least in part on the previously generated artificial scenario.

At (916), the method 900 can include selecting an artificial scenario from the artificial data 128 based at least in part on the authenticity data. For example, the artificial scenario computing system 200 can select the artificial scenario in the artificial data 128 when the authenticity data 129 associated with the artificial scenario is greater than an authenticity threshold value, as described herein. In some implementations, the artificial scenario computing system 200 can initiate a performance of a simulation based at least in part on the selected artificial scenario. In some implementations, the artificial scenario computing system 200 can initiate a performance of testing for an autonomous vehicle based at least in part on the selected artificial scenario.

In some implementations, the machine-learned generator model(s) 402 can generate artificial data 128 that includes a first artificial environment, and the machine-learned discriminator model(s) 404 can generate environment authenticity data associated with the first artificial environment. If environment authenticity data associated with a first artificial environment indicates that the artificial environment exceeds an authenticity threshold value (e.g., the machine-learned discriminator model(s) 404 determines that the first artificial environment is representative of a real-world environment), then the artificial scenario computing system 200 can select the first artificial environment for use in a simulation of the first artificial environment. The artificial scenario computing system 200 can provide such data to the simulation/testing system 220 (included and/or separate from the artificial scenario computing system 200), which can perform a simulation based at least in part on the first artificial environment. As another example, the machine-learned generator model(s) 402 can generate artificial data 128 that includes a first artificial log, and the machine-learned discriminator model(s) 129 can generate log authenticity data associated with the first artificial log. If log authenticity data associated with a first artificial log indicates that the artificial log exceeds an authenticity threshold value, then the artificial scenario computing system 200 can select the first artificial log for use in various testing. The artificial scenario computing system 200 can provide the first artificial log to the simulation/testing system 220, which can perform a development testing based at least in part on the first artificial log. This can include, for example, development testing of software versions that may be included an autonomous vehicle's autonomy software stack.

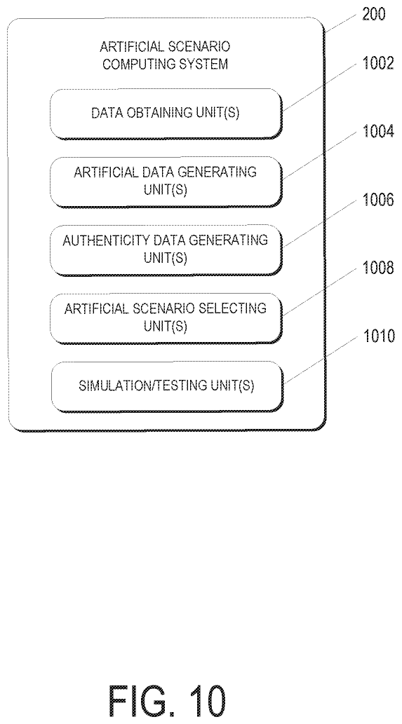

Various means can be configured to perform the methods and processes described herein. For example, FIG. 10 depicts a diagram of an example computing system 1000 that includes various means according to example embodiments of the present disclosure. The computing system 1000 can include data obtaining unit(s) 1002, artificial data generating unit(s) 1004, authenticity data generating unit(s) 1006, artificial scenario selecting unit(s) 1008, simulation/testing unit(s) 1010, and/or other means for performing the operations and functions described herein. In some implementations, one or more of the units may be implemented separately. In some implementations, one or more units may be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. For instance, the means (e.g., the data obtaining unit 1002) can be configured to obtain real-world data and/or generator input data (e.g., parameter input data and variance input data). As described herein, the real-world data can be used to train one or more GAN models to generate artificial data based at least in part on the generator input data. The means (e.g., the artificial data generating unit 1004) can be configured to generate artificial data (e.g., one or more artificial scenarios) based at least in part on generator input data. For example, the artificial data generating unit can include one or more machine-learned generator models. The machine-learned generator model(s) can be configured to receive generator input data, and output the artificial data based at least in part on the generator input data. The means (e.g., the authenticity data generating unit 1006) can be configured to generate authenticity data associated with one or more artificial scenarios in the artificial data. For example, the authenticity data generating unit can include one or more machine-learned discriminator models. The machine-learned discriminator model(s) can be configured to receive artificial data output by the artificial data generating unit, and output the authenticity data associated with one or more artificial scenarios represented by the artificial data. The means (e.g., the artificial scenario selecting unit 1008) can be configured to select an artificial scenario from the artificial data based at least in part on the authenticity data. For example, the artificial scenario selecting unit can be configured to select an artificial scenario that is associated with an authenticity that exceeds an authenticity threshold value. The means (e.g., the simulation/testing unit 1010) can be configured to simulate an artificial environment and/or test an artificial log. As an example, if the artificial scenario that is selected by the artificial scenario selecting unit includes an artificial environment, then the simulation unit can simulate the artificial environment to create a virtual world and allow for the measurement of vehicle system performance. As another example, if the artificial scenario that is selected by the artificial scenario selecting unit includes an artificial log, then the testing unit can use the artificial log to test vehicle system performance.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

Computing tasks, operations, and functions discussed herein as being performed at one computing system herein can instead be performed by another computing system, and/or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

The communications between computing systems described herein can occur directly between the systems or indirectly between the systems. For example, in some implementations, the computing systems can communicate via one or more intermediary computing systems. The intermediary computing systems may alter the communicated data in some manner before communicating it to another computing system.

The number and configuration of elements shown in the figures is not meant to be limiting. More or less of those elements and/or different configurations can be utilized in various embodiments.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method for vehicle simulation, the method comprising:
obtaining, by a computing system that includes one or more computing devices, generator input data indicative of one or more parameter values;
inputting, by the computing system, the generator input data into a machine-learned generator model that is configured to generate artificial data based at least in part on the generator input data, wherein the artificial data comprises data representing an artificial scenario associated with an autonomous vehicle;
obtaining an output of the machine-learned generator model, by the computing system, in response to inputting the generator input data into the machine-learned generator model, wherein the output comprises the artificial data;
inputting, by the computing system, the artificial data into a machine-learned discriminator model to generate authenticity data representing an authenticity associated with the artificial scenario of the artificial data;
obtaining an output of the machine-learned discriminator model, by the computing system, in response to inputting the artificial data into the machine-learned discriminator model, the output including the authenticity data; and
selecting, by the computing system, the artificial scenario in the artificial data when the authenticity associated with the artificial scenario is greater than an authenticity threshold value.

2. The computer-implemented method of claim 1, wherein the artificial scenario is indicative of an artificial autonomous vehicle environment and/or artificial autonomous vehicle log data.

3. The computer-implemented method of claim 1, the method further comprising:
inputting, by the computing system, existing data into the machine-learned generator model, the existing data representing a previously generated artificial scenario and an associated authenticity, wherein the artificial scenario is generated based at least in part on the existing data representing the previously generated artificial scenario and the associated authenticity.

4. The computer-implemented method of claim 3, wherein the artificial scenario that is based at least in part on the existing data is generated such that it is more likely to be determined as authentic compared to the previously generated artificial scenario.

5. The computer-implemented method of claim 3, wherein the machine-learned generator model is configured to adjust one or more parameter values associated with the previously generated artificial scenario to generate the artificial scenario that is based at least in part on the existing data.

6. The computer-implemented method of claim 1, wherein the generator input data is indicative of the one or more parameter values and one or more variance values associated with the one or more parameter values, and the machine-learned generator model is configured to generate the artificial data based at least in part on the one or more parameter values and the one or more associated variance values.

7. The computer-implemented method of claim 1, wherein the machine-learned generator model and the machine-learned discriminator model are trained based at least in part on real-world data.

8. The computer-implemented method of claim 1, wherein the machine-learned generator model is configured to generate the artificial data based at least in part on previously generated authenticity data associated with the generator input data.

9. The computer-implemented method of claim 1, the method further comprising:
initiating, by the computing system, a performance of a simulation based at least in part on the selected artificial scenario.

10. The computer-implemented method of claim 1, the method further comprising:
initiating, by the computing system, a performance of testing for an autonomous vehicle, based at least in part on the selected artificial scenario.

11. A computing system, the system comprising:
one or more processors; and
a computer-readable medium having instructions stored thereon that, when executed by the one or more processors, cause performance of operations comprising:
generating artificial data representing one or more artificial scenarios for an autonomous vehicle;
analyzing the artificial data to determine authenticity data representing an authenticity associated with the artificial data; and
selecting an artificial scenario from the artificial data, when the authenticity associated with the artificial scenario is greater than an authenticity threshold value.

12. The computing system of claim 10, wherein generating the artificial data comprises:
obtaining generator input data indicative of one or more parameter values associated with one or more artificial environments or one or more artificial logs;
inputting the generator input data into a machine-learned generator model to generate the artificial data based at least in part on the generator input data; and
obtaining an output of the machine-learned generator model in response to inputting the generator input data into the machine-learned generator model, the output including the artificial data.

13. The computing system of claim 11, wherein the machine-learned generator model is trained based at least in part on real-world data.

14. The computing system of claim 10, wherein analyzing the artificial data to determine the authenticity data comprises:
inputting the artificial data into a machine-learned discriminator model to generate the authenticity data; and
obtaining an output of the machine-learned discriminator model in response to inputting the artificial data into the machine-learned discriminator model, the output including the authenticity data.

15. The computing system of claim 13, wherein the machine-learned discriminator model is trained based at least in part on real-world data.

16. The computing system of claim 10, wherein generating the artificial data comprises:
obtaining existing data indicative of a previously generated artificial scenario and associated authenticity;
inputting the existing data into a machine-learned generator model to generate the artificial data, based at least in part on the existing data; and
obtaining an output of the machine-learned generator model in response to inputting the existing data into the machine-learned generator model, the output including the artificial data, wherein the artificial data includes at least one artificial scenario that is based on the existing data.

17. The computing system of claim 15, wherein obtaining the output of the machine-learned generator model comprises:
generating the at least one artificial scenario that is based on the existing data such that it is more likely to be determined as authentic compared to the previously generated artificial scenario.

18. The computing system of claim 10, the method further comprising:
initiating the performance of a simulation based at least in part on the selected artificial scenario.

19. The computing system of claim 10, the method further comprising:
initiating the performance of testing for an autonomous vehicle, based at least in part on the selected artificial environment or artificial log.

20. A non-transitory-computer-readable medium that stores instructions that when executed by one or more computing devices, cause the one or more computing devices to perform operations, the operations comprising:
generating artificial data representing one or more artificial environments of an autonomous vehicle or one or more artificial logs of an autonomous vehicle;
analyzing the artificial data to determine authenticity data representing an authenticity associated with the artificial data; and
selecting an artificial environment or an artificial log from the artificial data, when the authenticity data is greater than an authenticity threshold value.
